(19) United States
(12) Patent Application Publication
(10) Pub. No.: US 2009/0150014 A1
(43) Pub. Date: Jun. 11, 2009

(54) COMPLEX AUTOMATED SYSTEM AND METHOD OF DISPLAYING AUTOMATION AIDS

(75) Inventor: Jean-Philippe PINHEIRO, Toulouse (FR)

Correspondence Address: LOWE HAUPTMAN & BERNER, LLP, 1700 DIAGONAL ROAD, SUITE 300, ALEXANDRIA, VA, 22314, US

(73) Assignee: Thales, Neuilly Sur Seine (FR)

(21) Appl. No.: 12/327,091

(22) Filed: Dec. 3, 2008

(30) Foreign Application Priority Data
Dec. 7, 2007 (FR) 07 08546

(51) Int. Cl. G05D 1/10; G06F 3/048; G06G 7/66; G05B 15/02

(52) U.S. Cl. 701/11; 715/771; 700/83; 703/6

(57) ABSTRACT

A calculation system is disclosed having a pointing means. A display device presents the control interface of the system for the operator and the system triggering functions carries out a series of automation aids. The calculation system recovers the information descriptive of the automation aids programmed by the system while carrying out a function. The calculator system includes a means for displaying this information in a dialog area of the control interface of the function and has a direct access for the operator to the configuration of the parameters of the automation aids in the system. The invention applies to any complex automated system and finds a particularly beneficial application in respect of aircraft flight management systems.

### RELATED APPLICATIONS

The present application is based on, and claims priority from, French Application Number 0708546, filed Dec. 7, 2007, the disclosure of which is hereby incorporated by reference herein in its entirety.

### FIELD OF THE INVENTION

The field of the invention relates to any system comprising functions generating automation aids and also to the method of displaying the automation aids of the system for the operator.

### BACKGROUND OF THE INVENTION

Generally, automated complex systems require their operators to undergo coaching in order to understand them and master their operating mechanisms. For example, in the field of aeronautics, the automation aids managed by flight management systems have increased exponentially in terms of number in the course of technological advances. To use a system in complete safety, the operator must create for himself his own mental picture of this operating logic of the system. The operator then uses this mental picture to anticipate the behaviors of a complex system. Generally, coaching of pilots represents a significant proportion of airline costs in order that their personnel best master the operation of these constantly advancing systems. The problem domain is to reduce the burden of this coaching in the face of systems which are becoming ever more complex. It is known that human-computer interaction is a determining factor in the field of training in the use of complex calculation systems.

One avenue of improvement is to adapt the system to the operator's cognitive process. Despite their complexity and the growing number of integrated automation aids, flight management systems can be developed in such a way that their use is easier. This involves developing systems whose user interface allows their complexity to be better understood. However, the integration of more ergonomic interfaces requires greater space in the flight deck, which is moreover limited in respect of equipment integration. For example, on contemporary instrument panels, the dimension of the screens limits the possible solutions for rendering the operating mechanisms of systems transparent. However, advances in technology relating to instrument panel displays are making it possible henceforth to employ viewing screens of larger surface area, these screens then affording the possibility of displaying more information. Advances in screen technology are thus making it possible to improve the dialog between the operator and the system.

### SUMMARY OF THE INVENTION

More precisely, the present invention relates to a calculation system comprising a pointing means and a display device presenting the control interface of said system for the operator and said system triggering functions carrying out a series of automation aids, characterized in that the calculation system recovers the information descriptive of the automation aids programmed while carrying out a function, comprises a means for displaying this information in a dialog area of the control interface of the function and comprises a direct access for the operator to the configuration of the parameters of said automation aids in the system.

The invention also relates to a method of displaying an interface of a calculation system comprising a pointing means and a display device presenting the control interface of said system for the operator and said system triggering functions carrying out a series of automation aids, characterized in that, when a function is triggered during a first step, the method comprises the following steps:
In the second step, the interface window of the function is displayed on the viewing screen comprising a dialog area which comprises a list of icons of a first type representing the automation aids programmed by the system and icons of a second type associated distinctly with each icon of the first, each icon of the first type making it possible to open a window for configuring the parameters of the automation aid and each icon of the second type making it possible to cancel the programmed automation aid;
As long as the operator has not enabled the automation aids by selecting the icon, the system remains in the second step;
As long as the operator has not enabled the automation aids and if the operator moves the cursor onto the icon of a first type of an automation aid with the pointing means and selects it, in a third step the display device presents on the viewing screen a window for configuring the parameters of the automation aid; During this third step, the operator thereafter modifies the parameters of the automation aid chosen by the operator and the system returns to the second step;
As long as the operator has not enabled the automation aids and if the operator points to the icon (27) of the second type of an automation aid with the pointing means (31) and selects it, in a fourth step the system cancels the programmed automation aid and returns to the second step;
If the operator enables the automation aids by selecting the icon, in a final step the system executes the function according to the automation aids displayed in the dialog area.

The aim of the invention is to upload to the MMI level the automation aids carried out automatically by the complex system and usually invisible to the operator. The invention also makes it possible to render them directly accessible to the operator. This invention makes it possible to reduce automation surprises, with a potential gain in the safety of use of the systems and a reduction in the cost of coaching the user.

In aeronautical applications, flight management systems are becoming ever more complex and they incorporate automation aids which require lengthier training in order to be understood and mastered. The invention is advantageous since these automation aids, previously invisible to the operator, now allow him to construct a mental picture of the operation of the system.

Human behavior when faced with a machine is generally divided into three cognitive levels. The first level termed “Skill-base” corresponds to systems that may be manipulated by the human in an automatic or reflex manner. The second level termed “Rule-base” corresponds to systems where the human must respond when faced with a situation according to cause-consequence rules. The third level termed “Knowledge-base” corresponds to systems requiring a thorough knowledge of the system and a certain mental workload to manipulate them. Aircraft flight management systems are categorized at level three on account of their numerous integrated automation aids, invisible to the operator. The aim of the invention is to render the operation of these complex systems more understandable to the operator and ultimately to reduce the mental workload for manipulating these systems. Consequently, this invention is particularly suited to training simulators for aircraft and makes it possible to achieve a gain in terms of training effectiveness in respect of flight system coaching sessions. Indirectly, a system that is better mastered guarantees enhanced flight safety. Additionally, coaching represents a significant cost for airlines and the invention therefore represents, more generally, a means of improving the airline's economic performance.

Still other objects and advantages of the present invention will become readily apparent to those skilled in the art from the following detailed description, wherein the preferred embodiments of the invention are shown and described, simply by way of illustration of the best mode contemplated of carrying out the invention. As will be realized, the invention is capable of other and different embodiments, and its several details are capable of modifications in various obvious aspects, all without departing from the invention. Accordingly, the drawings and description thereof are to be regarded as illustrative in nature, and not as restrictive.

### BRIEF DESCRIPTION OF THE DRAWINGS

The present invention is illustrated by way of example, and not by limitation, in the figures of the accompanying drawings, wherein elements having the same reference numeral designations represent like elements throughout and wherein:

FIG. 1 represents an aircraft flight management system and a communication interface.

FIG. 2 represents an exemplary interface comprising the dialog area when a change of takeoff runway is involved.

FIG. 3 represents a chart of the interface method comprising the dialog box.

### DETAILED DESCRIPTION OF PREFERRED EMBODIMENT

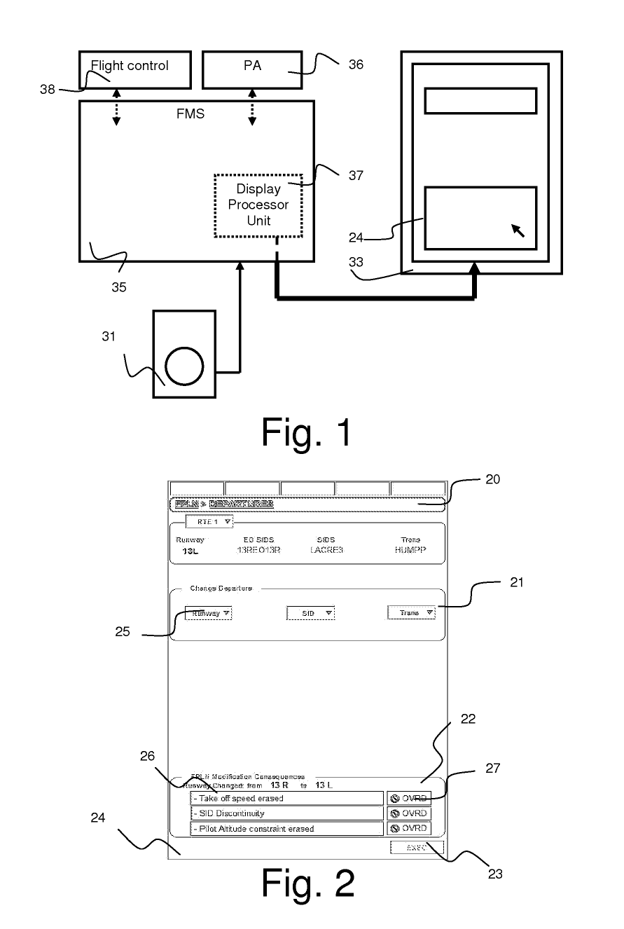

The interfaces of aircraft cockpits have advanced constantly so as to integrate technological advances. Flight management systems have also advanced so as to integrate ever more automated functions to assist the pilot in his task. As represented in FIG. 1, the flight management system 35 communicates and configures, automatically, several systems such as for example, to cite by way nonlimiting illustration, the automatic pilot 36 and the flight controls 38. With flight management systems becoming ever more complex, pilots are also being confronted with more difficulties in mastering their use. Consequently, airlines must resort to lengthier coaching. New technological advances in regard to viewing screens make it possible to use screens 33 of larger surface area and thus to display more information in the interface window 24 of the viewing units. It is then possible to put in place better uploading of information. In a general manner, the invention is advantageous in respect of any complex automated system requiring consequent training for its use.

By way of nonlimiting example, the invention applies to the flight management system of aircraft as well as the training simulators used for coaching pilots on these same systems. The invention makes it possible to upload up to the man-machine interface 33 the operation of the system and notably the automation aids involved in the functions of the system.

By way of nonlimiting example, FIG. 2 represents the case where a pilot executes a change of takeoff runway. He modifies the runway signaled 13R with the runway signaled 13L. The flight management system automatically executes automation aids when the function is carried out, such as the erasure of the takeoff speed for example. The window 24 is the interface of the system during the takeoff phase. The caption 20 of the situation is positioned at the top of the window 24. The function carrying out the change of takeoff runway appears in the part 21 of the screen. This function possesses input parameters such as the parameter 25 of the takeoff runway. It is known that when the system executes this function, automation aids are carried out automatically by the system. The invention makes it possible to display these automation aids (which previously were not retranscribed to the pilot) on the screen in the dialog area 22. In this example, this dialog area presents the operator with the consequences in the system and notably the operating logic which is executed due to the triggering of the takeoff runway reconfiguration function.

Furthermore, advantageously, each flight instruction programmed automatically by the system is represented in the dialog area by an icon 26 of a first type which is a means of direct access to a window for configuring the function for each respective flight instruction. This icon 26 is named in such a way that the automation aid configured by the system is understood by the pilot. The icon 26 of the first type can be, in one mode of implementation, a short line of text describing the instruction executed or else in another mode of implementation, a symbol sufficiently explicit for the operator to understand the flight instruction. Thus, the user views in the dialog area 22 the list of automation aids configured by the system. The invention allows the pilot to instinctively understand the operating mechanisms of the flight management system 35 and at the same time to have a means of modifying these automatic flight instructions which were previously invisible and inaccessible directly to the operator.

And additionally, advantageously, icons of a second type are associated distinctly with each icon of the first type. The icon of the second type 27 allows the operator to cancel the automation aid represented by the icon of the first type 26. In our nonlimiting example, the icon 27 is dubbed “OVRD” standing for “Overide” and makes it possible to cancel the takeoff speed erasure automation aid “Take off speed erased” engaged by the flight management system.

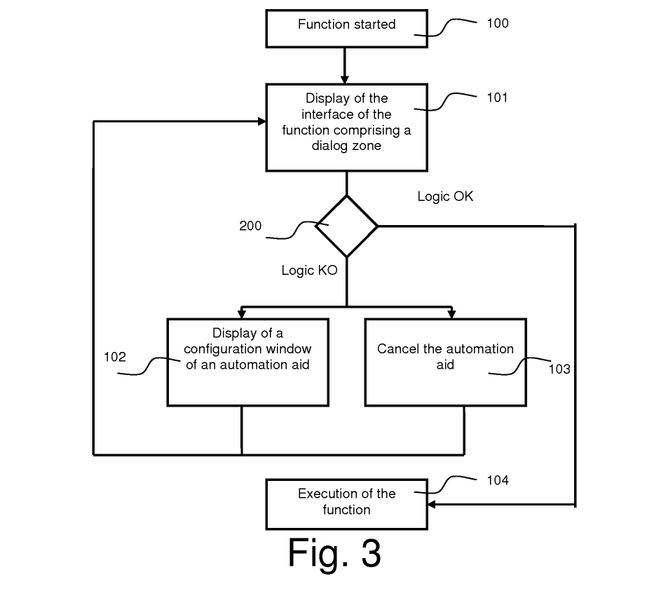

Furthermore, according to the invention and represented by FIG. 3, in step 101, by way of nonlimiting example, when the change of takeoff runway interface window is displayed, it comprises the following steps:
As long as the operator has not enabled the flight instructions by selecting the icon 23, the system remains in step 101;
If the operator moves the cursor onto the icon 26 of the takeoff speed erasure instruction with the pointing means and selects it, in a third step 102 the display device presents on the viewing screen a window for configuring the parameters of the takeoff speed; During this third step 102, the operator thereafter modifies the parameters of the flight instruction 26 and the system returns to step 101;
If the operator moves the cursor onto the icon 27 of the second type of a flight instruction with the pointing means and selects it, in a fourth step 103 the system cancels the takeoff speed erasure instruction 26 and maintains the speed previously programmed before the instigation of the change runway function and returns to step 101;
If the operator enables the flight instructions by selecting the icon 23, in a final step 104 the system executes the function according to the flight instructions displayed in the dialog area 22.

The system according to the invention has a means for detecting the flight instructions carried out automatically by the flight management system 35 of the aircraft. It thereafter reads the caption of the automation aids and displays it in the dialog area 22 a list of icons 26 representing these automation aids. These automation aids must be known to the pilot so that he becomes aware of the repercussions of an action on his part or of a function instigated automatically by the system. Flight management systems now carry out numerous automation aids which modify the aircraft's configuration state without however rendering it explicit to the operator. It may be dangerous if the operator is not aware of the configuration of the aircraft after carrying out a function having carried out automatic flight instructions and if he undertakes an action contradictory to this configuration state. The dialog area 22 is present to remind the operator of the consequences of the function and thus allows him to easily model the operation of the flight management system. It can happen that, in particular situations that occur exceptionally, at least one of the automation aids is not useful. Specifically, more generally there are always exceptions to the automation aid rules defined in complex systems. According to the invention, the pilot views the automation aids and can cancel them directly. Automated systems often result in the operator forgetting certain automatic instructions and when the operator finds himself in the exceptional case where it is not necessary to carry out the instruction, he may have forgotten through habit that it is necessary to deactivate an instruction. The invention is advantageous since it affords better safety of use and a better understanding of the mechanisms of a complex system.

The method according to the invention applies equally well to functions triggered by the user as to automatically engaged functions.

Aircraft display devices 35 now comprise computers 37 and can also carry out the method according to the invention.

It should be clear that the invention is not restricted to the field of aircraft flight management systems and that the examples of FIGS. 1 and 2 present an application taking particular advantage of the invention. By way of information, the invention can also be used for guidance systems of remotely piloted craft, such as drones or any other complex system carrying out automation aids.

It will be readily seen by one of ordinary skill in the art that the present invention fulfils all of the objects set forth above. After reading the foregoing specification, one of ordinary skill in the art will be able to affect various changes, substitutions of equivalents and various aspects of the invention as broadly disclosed herein. It is therefore intended that the protection granted hereon be limited only by definition contained in the appended claims and equivalents thereof.

1. A method of displaying an interface of a calculation system having a pointing means, a display device presenting the control interface of the system for the operator and the system triggering functions carrying out a series of automation aids, when a function is triggered during a first step, the method comprising the following steps:
in a second step, the interface window of the function is displayed on the viewing screen comprising a dialog area which comprises a list of icons of a first type representing the automation aids programmed by the system and icons of a second type associated distinctly with each icon of the first type, each icon of the first type making it possible to open a window for configuring the parameters of the automation aid and each icon of the second type making it possible to cancel the programmed automation aid;
as long as the operator has not enabled the automation aids by selecting the icon, the system remains in the second step; and
if the operator enables the automation aids by selecting the icon, in a final step the system executes the function according to the automation aids displayed in the dialog area.

2. The method as claimed in claim 1, wherein, as long as the operator has not enabled the automation aids and if the operator moves the cursor onto the icon of a first type of an automation aid with the pointing means and selects it, the method comprises a third step wherein the display device presents on the viewing screen a window for configuring the parameters of the automation aid; during this third step, the operator thereafter modifies the parameters of the automation aid chosen by the operator and the system returns to the second step.

3. The method as claimed in claim 2, wherein, as long as the operator has not enabled the automation aids and if the operator points to the icon of the second type of an automation aid with the pointing means and selects it, the method comprises a fourth step wherein the system cancels the programmed automation aid and returns to the second step.

4. The method as claimed in claim 3, wherein the function is triggered by the user.

5. The method as claimed in claim 4, wherein the function is triggered automatically by the system.

6. A calculation system comprising a pointing means, a display device presenting the control interface of said system for the operator and said system triggering functions carrying out a series of automation aids, wherein the calculation system comprises means making it possible to carry out the method as claimed in claim 5, these means being a means of recovering the information descriptive of the automation aids programmed while carrying out a function, a means for displaying this information in a dialog area of the control interface of the function and a means of direct access for the operator to the configuration of the parameters of said automation aids in the system.

7. A flight management system of an aircraft, comprising a system as claimed in claim 6.

8. A training simulator, comprising a system as claimed in claim 6.

9. A display device of an aircraft comprising a computer carrying out the method as claimed in claim 5.
